(19) United States
(12) Patent Application Publication
(10) Pub. No.: US 2015/0380153 A1
(43) Pub. Date: Dec. 31, 2015

(54) LAMINATED HIGH BIAS RETENTION FERRITE SUPPRESSORS AND METHODS OF MAKING THE SAME

(71) Applicant: Laird Technologies, Inc., Earth City, MO (US)

(72) Inventors: Yanhuan Zhu, Shenzhen (CN); Shufeng Huang, Shenzhen (CN); Jie Li, Shenzhen (CN)

(21) Appl. No.: 14/850,445

(22) Filed: Sep. 10, 2015

Related U.S. Application Data
(63) Continuation of application No. PCT/CN2013/072750, filed on Mar. 15, 2013.

(51) Int. Cl. H01F 27/28; H01F 41/32; H01F 27/245

(52) U.S. Cl. CPC H01F 27/2804; H01F 27/245; H01F 41/32; H01F 2027/2809

(57) ABSTRACT

Disclosed are exemplary embodiments of chip type high bias retention suppressors that have a laminated structure, which comprises a ferrite magnetic substrate, dielectric material layers, and interior electrically-conductive or conductor layers. The internal electrical conductors may be printed (e.g., silver ink, etc.) on the magnetic layers such that the conductors connect with each other and define a spiral pattern or coil. The dielectric layers and/or interior conductors may be laminated on the magnetic substrate in a direction of thickness. The dielectric layers and/or interior connectors may be printed by a thick-film process.

### CROSS-REFERENCE TO RELATED APPLICATION

This application is a continuation of PCT International Application No. PCT/CN2013/072750 filed Mar. 15, 2013 (now published as WO 2014/139169). The entire disclosure of the above application is incorporated herein by reference.

### FIELD

The present disclosure generally relates to laminated high bias retention ferrite suppressors and methods of making the same.

### BACKGROUND

This section provides background information related to the present disclosure which is not necessarily prior art.

A typical ferrite surface mount electromagnetic interference (“EMI”) suppressor includes a generally rectangular ferrite body with an electrically conductive path extending therethrough. The electrically conductive path, in turn, is connected to respective conductive coating layers on opposite ends of the ferrite body to facilitate connection to a printed circuit board, for example. Such a ferrite EMI suppressor may commonly be manufactured by printing a plurality of interconnected conductive traces on successive stacked ferrite layers.

Conventional chip type, surface mount, ferrite EMI suppressors are commonly manufactured by screen printing a plurality of conductive traces on a relatively rigid base ferrite tape, and positioning a second relatively rigid ferrite tape thereon. The thus formed multilayer structure is heated under pressure to form a monolithic structure. Unfortunately, the conventional screen printing process limits the thickness of the electrically conductive material, typically a silver or other precious metal paste. Accordingly, the current carrying capability of such a device may be severely limited, that is, on the order of only several milliamperes.

### SUMMARY

This section provides a general summary of the disclosure, and is not a comprehensive disclosure of its full scope or all of its features.

According to various aspects, exemplary embodiments are disclosed of suppressors. Also disclosed are methods for making or manufacturing suppressors. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a suppressor according to an exemplary embodiment;

FIG. 2 is an exploded perspective view of the suppressor shown in FIG. 1 and illustrating its magnetic ferrite substrate that may be formed by tape casting and its conductor patterns and dielectric layer that may be formed on the magnetic ferrite substrate by thick-film printing according to exemplary embodiments;

FIG. 3 is a perspective view illustrating the suppressor shown in FIG. 1 surface mounted on a circuit board with the suppressor's electrical end conductors connected with traces on the circuit board according to an exemplary embodiment;

FIG. 4 is a perspective view illustrating the suppressor shown in FIG. 1 applied in a power line to filter noise associated with automobile electronics according to an exemplary embodiment; and

FIGS. 5 through 11 provide various performance test data measured for physical suppressor prototypes according to the exemplary embodiment shown in FIG. 1, which test results are provided only for purposes of illustration and not for purposes of limitation.

Corresponding reference numerals indicate corresponding parts throughout the several views of the drawings.

### DETAILED DESCRIPTION

Example embodiments will now be described more fully with reference to the accompanying drawings.

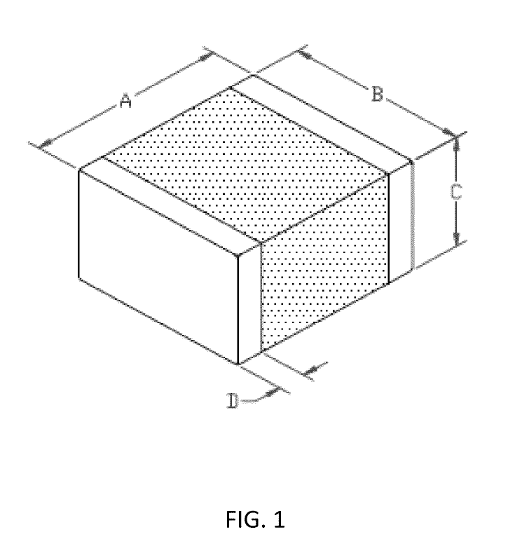

The inventors hereof have recognized that some existing small or compact ferrite EMI and/or noise suppressors are incapable of retaining or keeping high inductance or impedance under large DC-bias. After recognizing the above, the inventors hereof developed and disclose herein exemplary embodiment's ferrite EMI and/or noise suppressors (e.g., suppressor shown in FIG. 1, etc.) that have a high bias retention even though compact or small in size.

For example, disclosed herein are exemplary embodiments of chip type high bias retention suppressors that have a laminated structure (e.g., FIG. 1, etc.), which comprises a ferrite magnetic substrate, dielectric material layers, and interior electrically-conductive or conductor layers. Magnetic material may be the main part of the substrate. Dielectric material forms an air gap that interrupts the magnetic routine thus allowing the parts to keep high inductance or impedance under large DC-bias. The internal electrical conductors may be printed (e.g., silver ink, etc.) on the magnetic layers such that the conductors connect with each other and define a spiral pattern or coil. The dielectric layers and/or interior conductors may be laminated on the magnetic substrate in a direction of thickness. The dielectric layers may be printed on a conductor pattern by a thick-film process to electrically insulate them.

Advantageously, the exemplary embodiments of laminated high bias retention ferrite suppressors disclosed herein may provide enhanced performance over other existing suppressors (e.g., have a higher bias retention of inductance or impedance under large DC-bias even though compact or small in size, etc.) and/or may be manufactured by a more simple or less complex manufacturing process as it has fewer components (layers) than some other existing suppressors, which reduced part count may also reduce manufacturing costs.

FIG. 1 illustrates an exemplary embodiment of a suppressor embodying one or more aspects of the present disclosure. As shown in FIG. 1, the suppressor has a monolithic structure in that its components may be mounted directly onto surfaces of laminated layers of the magnetic ferrite substrate by surface mount technology (SMT). The suppressor can be used in power circuits, such as automotive electronics, etc., to filter or suppress noise.

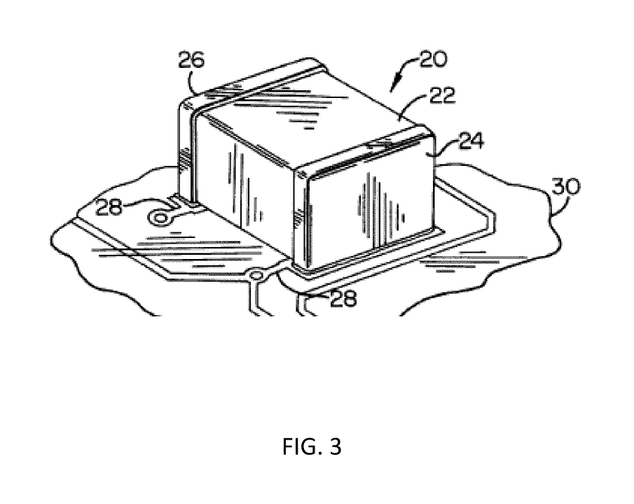

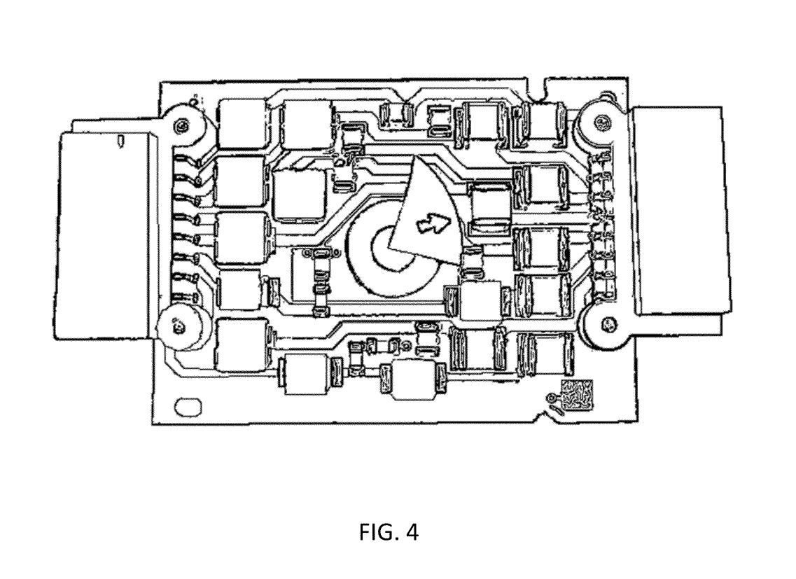

For example, FIG. 3 shows a suppressor 20 having a ferrite body 22 and electrical end conductors 24 and 26. As shown, the suppressor 20 is surface mounted on a circuit board 30 with the suppressor's electrical end conductors 24 and 26 connected with traces 28 on the circuit board 30. By way of further example, FIG. 4 shows a suppressor applied in a power line to filter noise associated with automobile electronics.

With continued reference to FIG. 1, the suppressor is illustrated with a generally rectangular body. The body is box-shaped or a cuboid having six generally rectangular flat sides. Alternative embodiments may be shaped differently, e.g., shaped as a cube or prism, etc.

A first pair of end conductors 24 (FIG. 3) are located on or at a first end portion of the magnetic ferrite substrate or ferrite body 22. A second pair of end conductors 26 is on or at a second end portion of the magnetic ferrite substrate 22. The first and second end portions of the magnetic ferrite substrate 22 face in opposite directions to each other.

The tables below provides representative physical dimensions for a suppressor according to the exemplary embodiment shown in FIG. 1. These dimensions (as are all dimensions herein) are examples only as other embodiments may be sized differently.

| | Millimeters [Inches] | | Tolerance in Millimeters [Inches] |
|---|---|---|---|
| A | 5.59 [.220] | ± | 0.51 [.010] |
| B | 5.08 [.200] | ± | 0.25 [.010] |
| C | 3.61 [.142] | ± | 0.25 [.010] |
| D | 0.76 [.030] | ± | 0.13 [.010] |
| | Millimeters | | Tolerance in Millimeters [Inches] |
| A | 5.08 | ± | 0.51 [.010] |
| B | 4.83 | ± | 0.25 [.010] |
| C | 3.36 | ± | 0.25 [.010] |
| D | 0.51 | ± | 0.13 [.010] |
| A | 6.10 | ± | 0.51 [.010] |
| B | 5.33 | ± | 0.25 [.010] |
| C | 3.86 | ± | 0.25 [.010] |
| D | 1.01 | ± | 0.13 [.010] |

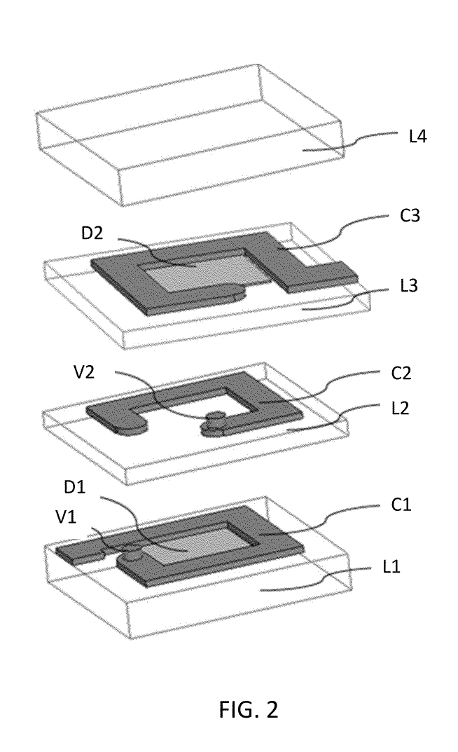

FIG. 2 is an exploded perspective view of the suppressor shown in FIG. 1. As shown in FIG. 2, the magnetic ferrite substrate includes first, second, third, and fourth layers or portions L1, L2, L3, and L4, which are joined together, e.g., layers of ferrite tape laminated together to form the substrate. The layers L1, L2, L3, and L4 may be formed by tape casting, etc.

The suppressor also includes electrically-conductive material forming first, second, and third interior conductors C1, C2, and C3. The conductors C1, C2, and C3 and their patterns may be formed on the magnetic ferrite substrate by thick-film printing, etc. Various electrically-conductive materials may be used for the interior conductors C1, C2, and C3. By way of example only, the materials forming the conductor patterns may generally include silver, gold, silver palladium alloy, etc. By way of further example, the electrically-conductive material (e.g., silver, gold, silver palladium alloy, etc.) may first be formed into an electrically-conductive conductive ink or paste, which is then printed on the magnetic layers L1, L2, and L3 of the substrate to form the conductor patterns of the interior conductors C1, C2, and C3.

The suppressor further includes first and second dielectric layers or portions D1 and D2. The dielectric layers D1 and D2 may be formed on the magnetic ferrite substrate by thick-film printing, etc.

Each magnetic layer L1, L2, and L3 of the magnetic ferrite substrate has only one conductor pattern thereon. Specifically, the layer L1 includes the conductor C1. The layer L2 includes the conductor C2. The layer L3 includes the conductor C3. Notably, the top layer L4 of the magnetic ferrite substrate does not include a conductor.

In addition, the conductors C1, C2, and C3 are provided or configured with or in spiral or coil conductor patterns. In this exemplary embodiment, the conductors C1, C2, and C3 have generally rectangular spiral or coil conductor patterns. The first and second pairs of end conductors 24 and 26 (FIG. 3) may each be electrically connected to the conductors C1, C2, and C3.

As shown in FIG. 2, the suppressor includes first and second connectors V1 and V2. By way of example, the connectors V1 and V2 may comprise electrically-conductive vias or thru-holes that are punched or otherwise formed in the layers L1, L2, and L3 of the magnetic ferrite substrate. The thru-holes or vias are plated or filled with electrically-conductive material (e.g., silver, gold, silver palladium alloy, etc.). For example, the thru-holes or vias may be filled with electrically-conductive ink or paste by thick-film printing such that the electrically-conductive material extends through the layers L1, L2, and L3 of the magnetic ferrite substrate for connecting the conductors on opposite sides of the layers L1, L2, and L3.

The conductors C1 and C2 include terminals or end portions electrically connected by the connector V1. By extending through the ferrite layer L2, the connector V1 is able to electrically connect the terminals of conductors C1 and C2 even though they are along or on opposite sides of the ferrite layer L2. Similarly, the conductors C2 and C3 includes terminals or end portions that are along or on opposite sides of the ferrite layer L3. The connector V2 extends through the ferrite layer L2 to electrically connect the terminals of conductors C2 and C3.

The conductors C1, C2, and C3 and their patterns may be formed by a thick film process on the upper surfaces of the layers L1, L2, and L3. This exemplary embodiment thus includes the interior conductors C1, C2, and C3 that are internal to or inside the magnetic ferrite substrate and also includes the end conductors that are exposed on the outside of the magnetic ferrite substrate.

The first dielectric material layer D1 is formed or provided between the layers L1 and L2, such that the dielectric layer D1 is disposed generally within an opening of or surrounded by at least a portion of the conductor C1. The second dielectric material layer D2 is formed or provided between the layers L3 and L4, such that the dielectric layer D2 is disposed generally within an opening of or surrounded by the conductor C3. In this exemplary embodiment, the dielectric material layers D1 and D2 have a configuration, shape, or pattern that substantially matches or corresponds to the interior openings (e.g., rectangular, etc.) of the conductors C1 and C3. Also, the dielectric layers D1 and D2 are thinner or shorter in height than the corresponding conductors C1 and C3. With this difference in height or thickness, dielectric air gaps may be formed that interrupt the magnetic routine and allow the parts to keep high inductance or impedance under large DC-bias.

The dielectric material layers D1 and D2 may be formed or printed by a thick film process on the respective ferrite layers L1 and L3. The dielectric material layers D1 and D2 may comprise a non-magnetic dielectric material, such as Titania or titanium dioxide, for example, although other materials may also be used.

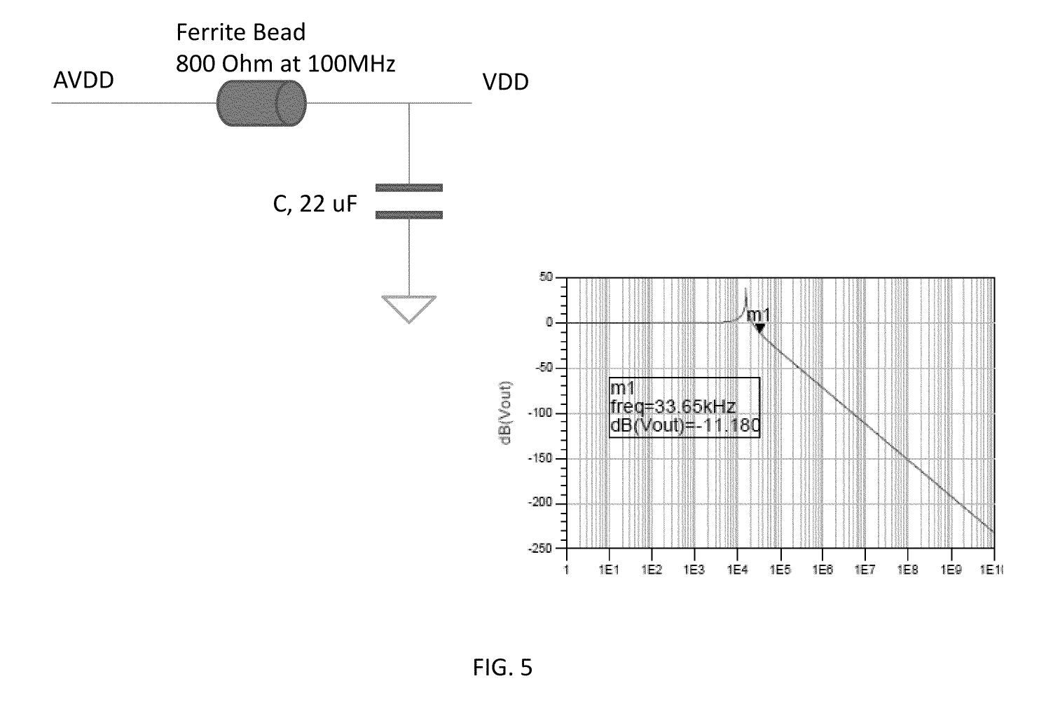

FIGS. 5 through 11 provide analysis results measured for sample suppressor prototypes according to the exemplary embodiment shown in FIG. 1. These analysis results shown in FIGS. 5 through 11 are provided only for purposes of illustration and not for purposes of limitation.

FIG. 5 shows an application example for a suppressor as a LC power filter for network switch integrated circuits. In this example, the intention of the LC filter is to attenuate select AC components on a particular DC power rail according to LC filter specifications (e.g., cutoff frequency, stop-band, attenuation, etc.). In low current applications, the LC power filter has a distinct size advantage and a steeper negative 40 decibel/decade cutoff response as shown in the line graph when compared to caps.

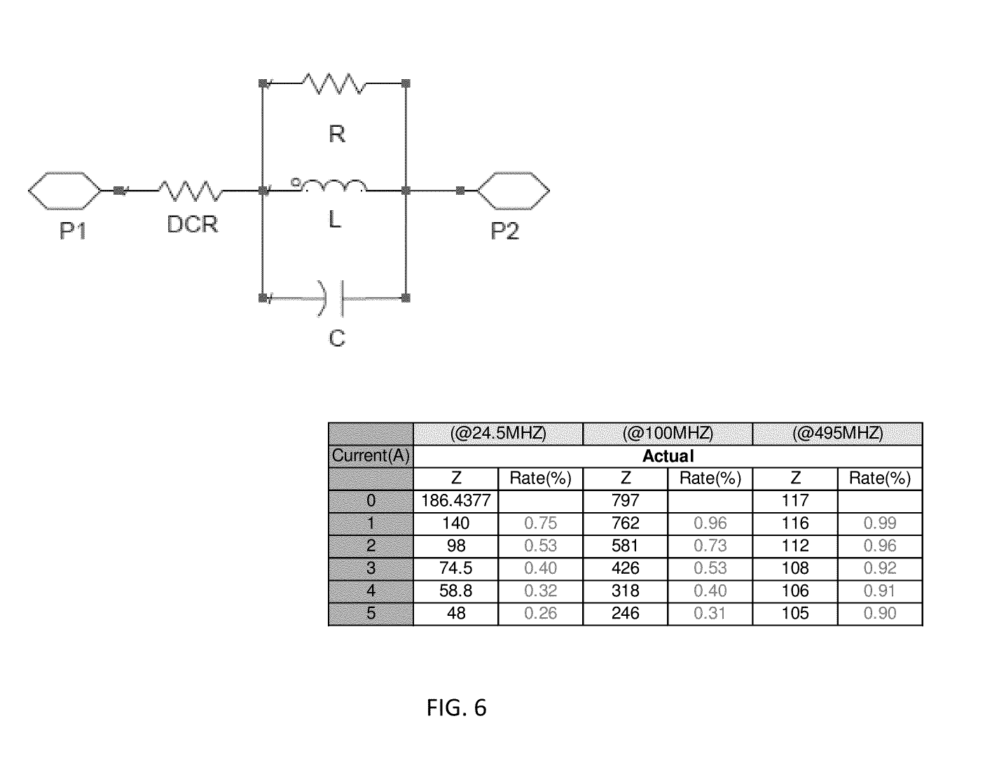

FIG. 6 includes an equivalent circuit model for a ferrite bead, where DCR (direct current resistance) is corresponding to DC (direct current) performance. R-L-C (resistor-inductor-capacitor) is corresponding to the AC (alternating current) performance under certain DC bias current levels. FIG. 6 also includes a table showing high DC bias at different frequencies and currents.

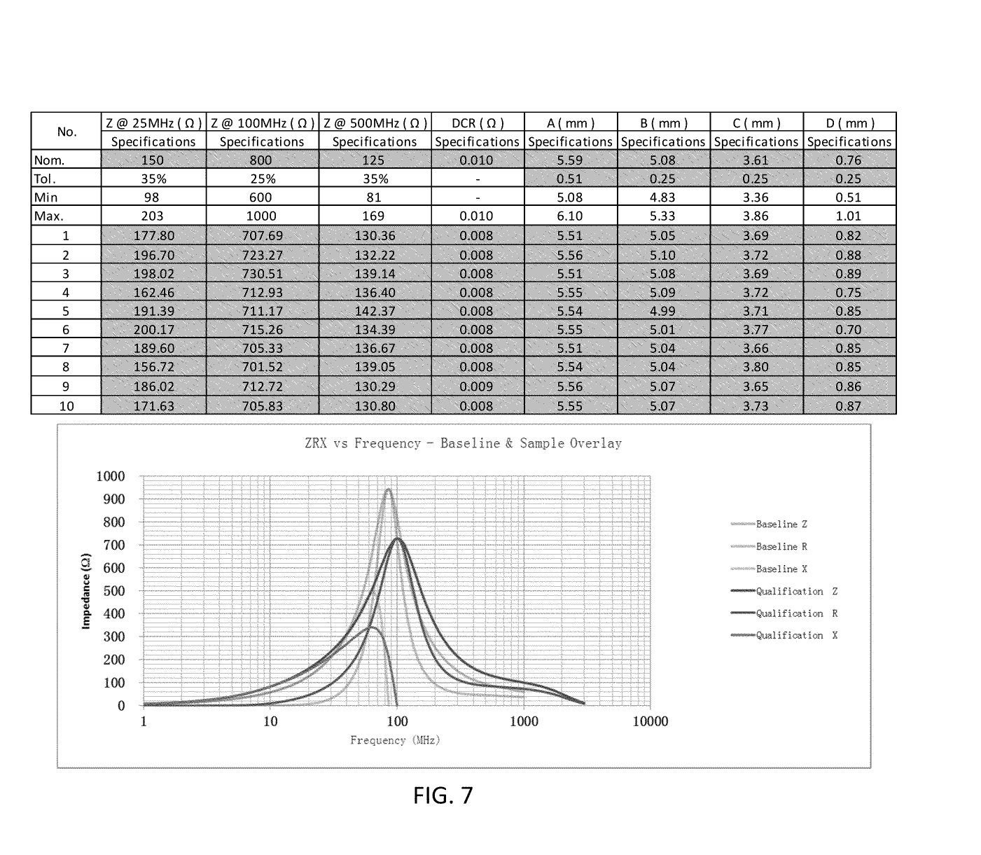

FIG. 7 includes test data relating to electrical properties of the suppressor. As shown by FIG. 7, the suppressor had passing or satisfactory electrical performance. FIG. 7 also includes an exemplary line graph including plots of impedance (Z), resistance (R), and inductive reactance (X) (all in ohms) versus frequency (in megahertz).

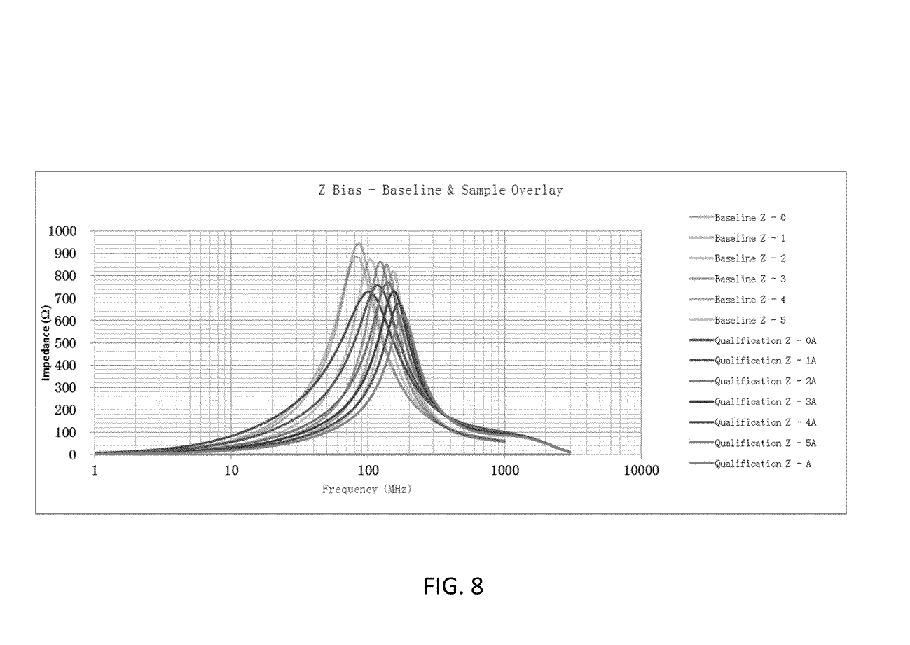

FIG. 8 shows that the suppressor has satisfactory DC bias. This is shown by the exemplary line graph including plots of impedance (Z)) (in ohms) versus frequency (in megahertz).

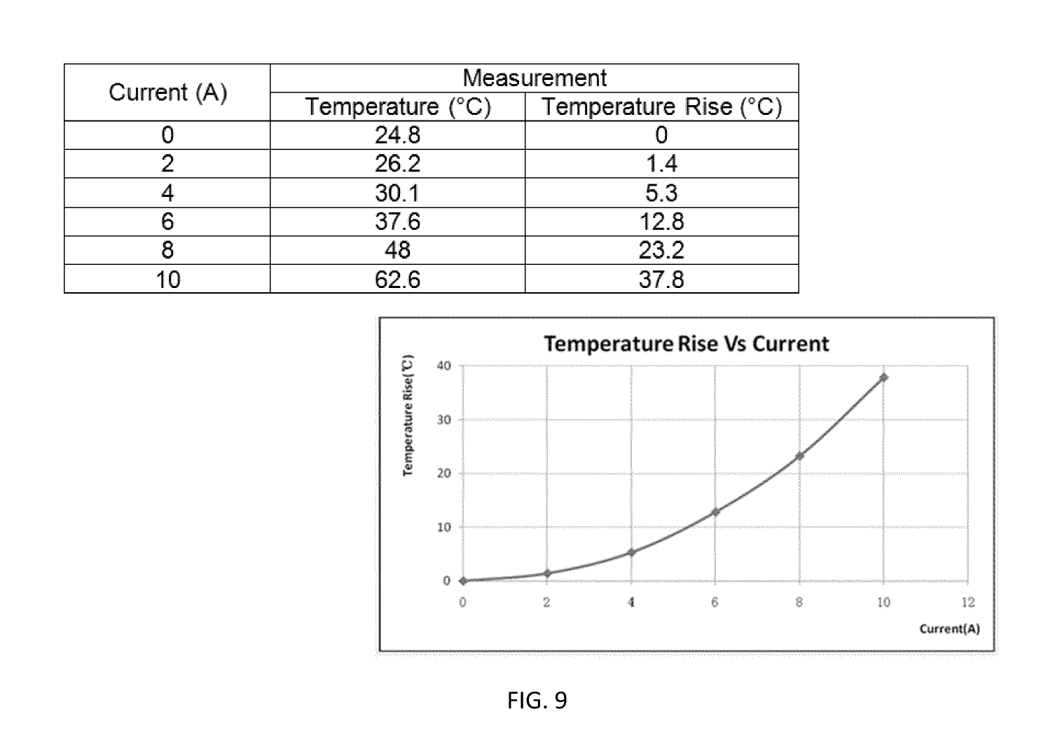

FIG. 9 shows that the suppressor has satisfactory rated current. This is shown by the line graph of temperature rise (in degrees Celsius) versus current (in amps).

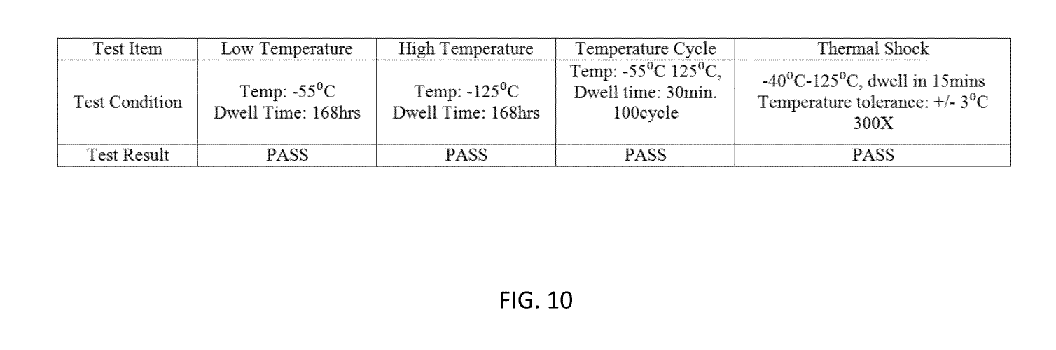

FIG. 10 provides reliability test data obtained by long term reliability testing, short term reliability testing, and vibrational mechanical testing. As shown by FIG. 10, the suppressor had passing or satisfactory reliability.

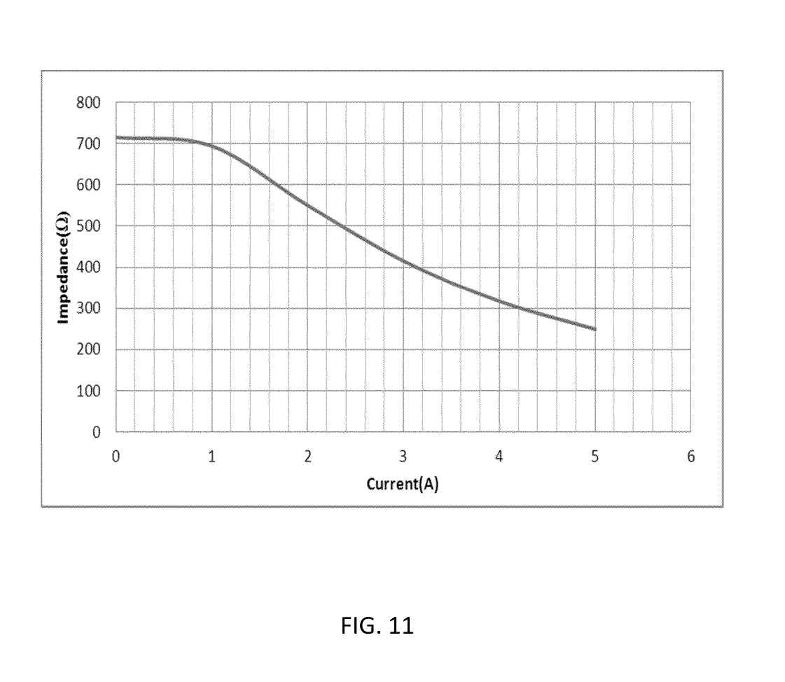

FIG. 11 includes an exemplary line graph of impedance (in ohms) versus current (in amps). Generally, FIG. 11 shows that a gradual or slow decrease in impedance for increasing current.

Also disclosed are exemplary embodiments of methods of making or manufacturing suppressors (e.g., suppressor shown in FIGS. 1 and 2, etc.) having a laminated structure which is comprised of a magnetic substrate, dielectric material layers, and interior conductors. The dielectric material layers and interior conductors may be laminated on the magnetic substrate in a direction of thickness.

In an exemplary embodiment, a method generally includes forming a magnetic substrate by tape casting, such that the magnetic substrate includes a plurality of layers. In this example, the magnetic substrate may each include four ferrite tape layers.

This exemplary method also includes forming electrical conductors on surfaces of the layers of the magnetic substrate by a thick film process. The electrical conductors may be printed by the thick film process on corresponding layers of the magnetic substrate. The method further includes forming dielectric layers on the magnetic substrate by a thick film process. Accordingly, the conductors and dielectric layers are thus formed such that they are within or internal to the magnetic substrate.

In addition, the method includes forming or providing first and second pairs of end conductors on the respective first and second end portions of the magnetic substrate. The end conductors are electrically connected to the interior conductors. The first and second end portions face in opposite directions to each other.

The method further includes providing, forming, or establishing an electrical connection between the terminals of the interior conductors. These electrical connections may be established by using connectors, such as vias or thru-holes extending through the layers separating the terminals to be connected and filled with electrically-conductive material (e.g., filled with electrically-conductive ink by thick-film printing, etc.). The uppermost or top layer of the upper portion does not include any such vias or thru-holes in this example. Likewise, the lowermost or bottom layer of the lower portion also does not include any such vias or thru-holes in this example.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances. Or for example, the term “about” as used herein when modifying a quantity of an ingredient or reactant of the invention or employed refers to variation in the numerical quantity that can happen through typical measuring and handling procedures used, for example, when making concentrates or solutions in the real world through inadvertent error in these procedures; through differences in the manufacture, source, or purity of the ingredients employed to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section could be termed a second element, component, region, layer or section without departing from the teachings of the example embodiments.

Spatially relative terms, such as “inner,” “outer,” “beneath,” “below,” “lower,” “above,” “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A laminated high bias retention suppressor comprising:
a magnetic substrate including first, second, third, and fourth layers;
a first interior conductor on a top surface of the first layer of the magnetic substrate;
a second interior conductor on a top surface of the second layer of the magnetic substrate;
a third interior conductor on a top surface of the third layer of the magnetic substrate;
a first dielectric layer on the top surface of first layer of the magnetic substrate with at least a portion of the first interior conductor disposed around the first dielectric layer; and
a second dielectric layer on the top surface of third layer of the magnetic substrate with at least a portion of the third interior conductor disposed around the second dielectric layer;
wherein end portions of the first, second, and third interior conductors are connected so as to define a spiral pattern or coil.

2. The suppressor of claim 1, wherein the first and second dielectric layers are thinner or shorter in height than the corresponding first and third interior conductors, whereby the difference in height or thickness forms dielectric air gaps within the suppressor.

3. The suppressor of claim 2, wherein:
the first, second, third, and fourth layers of the magnetic substrate comprises ferrite tape layers formed by a tape casting;
the first interior conductor is printed on the top surface of the first layer of the magnetic substrate by a thick film process;
the second interior conductor is printed on the top surface of the second layer of the magnetic substrate by a thick film process;
the third interior conductor is printed on the top surface of the third layer of the magnetic substrate by a thick film process;
the first dielectric layer is printed on the top surface of first layer of the magnetic substrate by a thick film process; and
the second dielectric layer is printed on the top surface of third layer of the magnetic substrate by a thick film process.

4. The suppressor of claim 2, further comprising:
a first connector extending through the second layer of the magnetic substrate and electrically connecting the first interior conductor to the second interior conductor; and
a second connector extending through the third layer of the magnetic substrate and electrically connecting the second interior conductor to the third interior conductor.

5. The suppressor of claim 1, wherein the first and second dielectric layers form air gaps that interrupt the magnetic routine thus retaining high inductance or impedance under large DC-bias.

6. The suppressor of claim 5, wherein:
the first, second, third, and fourth layers of the magnetic substrate comprises ferrite tape layers formed by a tape casting;
the first interior conductor is printed on the top surface of the first layer of the magnetic substrate by a thick film process;
the second interior conductor is printed on the top surface of the second layer of the magnetic substrate by a thick film process;
the third interior conductor is printed on the top surface of the third layer of the magnetic substrate by a thick film process;
the first dielectric layer is printed on the top surface of first layer of the magnetic substrate by a thick film process; and
the second dielectric layer is printed on the top surface of third layer of the magnetic substrate by a thick film process.

7. The suppressor of claim 5, further comprising:
a first connector extending through the second layer of the magnetic substrate and electrically connecting the first interior conductor to the second interior conductor; and
a second connector extending through the third layer of the magnetic substrate and electrically connecting the second interior conductor to the third interior conductor.

8. The suppressor of claim 1, wherein:
the first, second, third, and fourth layers of the magnetic substrate comprises ferrite tape layers formed by a tape casting;
the first interior conductor is printed on the top surface of the first layer of the magnetic substrate by a thick film process;
the second interior conductor is printed on the top surface of the second layer of the magnetic substrate by a thick film process;
the third interior conductor is printed on the top surface of the third layer of the magnetic substrate by a thick film process;
the first dielectric layer is printed on the top surface of first layer of the magnetic substrate by a thick film process; and
the second dielectric layer is printed on the top surface of third layer of the magnetic substrate by a thick film process.

9. The suppressor of claim 1, further comprising:
a first connector extending through the second layer of the magnetic substrate and electrically connecting the first interior conductor to the second interior conductor; and
a second connector extending through the third layer of the magnetic substrate and electrically connecting the second interior conductor to the third interior conductor.

10. The suppressor of claim 9, wherein the first and second connectors comprise electrically-conductive vias.

11. A suppressor comprising:
a magnetic substrate including first, second, third, and fourth layers;
a first interior conductor on a top surface of the first layer of the magnetic substrate;
a second interior conductor on a top surface of the second layer of the magnetic substrate;
a third interior conductor on a top surface of the third layer of the magnetic substrate;
a first dielectric layer on the top surface of first layer of the magnetic substrate; and
a second dielectric layer on the top surface of third layer of the magnetic substrate;
whereby at least one of the first and second dielectric layers forms an air gap that interrupts the magnetic routine thus retaining high inductance or impedance under large DC-bias.

12. The suppressor of claim 11, wherein:
an air gap is between the first dielectric layer and the second layer of the magnetic substrate; and
an air gap is between the second dielectric layer and the fourth layer of the magnetic substrate.

13. The suppressor of claim 11, wherein:
an air gap is between the first dielectric layer and the second layer of the magnetic substrate; or
an air gap is between the second dielectric layer and the fourth layer of the magnetic substrate.

14. A method of making a suppressor comprising:
tape casting a magnetic substrate such that the magnetic substrate includes first, second, third, and fourth ferrite tape layers;
forming a first interior conductor by a thick film process such that the first interior conductor is on a top surface of the first ferrite tape layer;
forming a second interior conductor by a thick film process such that the second interior conductor is on a top surface of the second ferrite tape layer;
forming a third interior conductor by a thick film process such that the third interior conductor is on a top surface of the third ferrite tape layer;
forming a first dielectric layer by a thick film process such that the first dielectric layer is on the top surface of the first ferrite layer with an air gap between the first dielectric layer and the second ferrite tape layer; and
forming a second dielectric layer by a thick film process such that the second dielectric layer is on the top surface of the third ferrite layer with an air gap between the second dielectric layer and the fourth ferrite tape layer.

15. The method of claim 14, wherein the air gaps interrupt the magnetic routine of the suppressor thus retaining high inductance or impedance under large DC-bias.
